(19) United States
(12) Patent Application Publication
(10) Pub. No.: US 2012/0067599 A1
(43) Pub. Date: Mar. 22, 2012

(54) MINI-TYPE AUTOMATIC AEROSOL FIRE SUPPRESSION APPARATUS

(75) Inventors: Hongbao Guo, Xi'an (CN); Weipeng Zhang, Xi'an (CN); Zanfeng Zhang, Xi'an (CN); Zhenping Deng, Xi'an (CN); Qian Liu, Xi'an (CN); Tengfei Zhai, Xi'an (CN); Sanxue Zhang, Xi'an (CN); Guoxing Zhang, Xi'an (CN); Kun Zhang, Xi'an (CN)

(73) Assignee: SHAANXI J & R FIRE FIGHTING CO., LTD., Xi'an (CN)

(21) Appl. No.: 13/322,444

(22) PCT Filed: Jun. 6, 2010
(86) PCT No.: PCT/CN10/73591

§ 371 Date: Nov. 23, 2011

(30) Foreign Application Priority Data
Jun. 8, 2009 (CN) 200920033447.3

(51) Int. Cl. A62C 35/11

(52) U.S. Cl. 169/26

(57) ABSTRACT

The present invention relates to a mini-type automatic aerosol fire suppression apparatus, comprising top cap (1), thermal insulating layer (3), inner cylinder (4), outer cylinder (5), bottom cap (7), sensing element (8), screen (9) and igniter (11), wherein a chemical agent (6) and a cooling layer (10) are installed in the inner cylinder (4), the thermal insulating layer (3) is installed between the inner cylinder (4) and the outer cylinder (5), and the sensing element (8) is designed to sense fire. The volume of the apparatus is not greater than 0.05 m³. Compared to that in the prior art, the apparatus is delicate and easy to install, and is suitable for quick local fire suppression, and can get twice the result with half the effort in such applications.

### FIELD OF THE INVENTION

The present invention belongs to the technical field of gas fire suppression apparatuses, and relates to a mini-type automatic aerosol fire suppression apparatus that is applicable to a variety of fire hazard locations where the space is small and enclosed and the equipment is of high value and unattended.

### BACKGROUND OF THE INVENTION

Nowadays, aerosol fire suppression apparatuses are widely applied due to their advantages such as excellent fire suppression performance, safety, reliability, stability, environment friendliness and easy operation. Aerosol fire suppression apparatuses have been successfully applied in thousands of projects in more than 30 provinces throughout the country, involving industries and enterprises such as China Mobile, China Unicom, China Telecom, metallurgical and energy sectors.

However, existing aerosol products can't meet the market demand. In many small spaces where power utilization, distribution, and transformation are involved, such as transformers, distribution cabinets, engine compartments and luggage compartments on vehicles, etc., and at locations on aircrafts, vehicles, or ships where gasoline, diesel oil, or aviation kerosene is used for propulsion, fire resulted from fire hazards such as aged cables and wires, fuel leakage, and harsh environment, etc. is usually difficult to discover and detect in the early stage. Often, a spark may cause a severe fire disaster so that severe personal injuries and death and equipment damage can happen. In these circumstances, quick local fire suppression may get twice the result with half the effort. Therefore, fire control experts at home and abroad always regard highly the development and research of mini-type quick fire suppression apparatuses. However, no mini-type automatic fire suppression apparatus in which the charge amount is less than 1 Kg and the temperature at the jet orifice is lower than 150° C. is seen in the market yet.

### SUMMARY OF THE INVENTION

In view of the present situation in the prior art, the object of the present invention is to provide a mini-type automatic aerosol fire suppression apparatus that is applicable to a variety of fire hazard locations where the space is small and enclosed and the equipment is of high value and unattended.

The present invention provides the mini-type automatic aerosol fire suppression apparatus, comprising top cap, thermal insulating layer, inner cylinder, outer cylinder, bottom cap, sensing element, screen and igniter, wherein a chemical agent and a cooling layer are installed in the inner cylinder, the thermal insulating layer is installed between the inner cylinder and the outer cylinder, and the sensing element is designed to sense fire.

Furthermore, the initiation of the aerosol fire suppression apparatus is electric initiation, which is accomplished by means of the sensing element and a battery.

Furthermore, the sensing element is a temperature detector, smoke detector, flame detector or gas detector.

Furthermore, the initiation of the aerosol fire suppression apparatus is non-electric initiation, which is accomplished by connecting a heat-sensitive material, pyrophoric material or fire transfer material to a chemical agent.

Furthermore, the aerosol fire suppression apparatus is installed by fixing with screws, attaching to the surface of an iron or steel structure by means of magnetic attraction or bonding.

Furthermore, the apparatus further comprises a detection circuit board, which is designed to detect the battery capacity.

Furthermore, a safety switch designed to prevent false initiation is arranged on the detection circuit board.

Furthermore, the apparatus further has a feedback element designed to detect whether or not the apparatus spurts out the aerosol, and the feedback element is an indicator or buzzer.

Furthermore, the material of the thermal insulating layer is aluminum silicate fiber or asbestos.

Furthermore, the volume of the mini-type automatic aerosol fire suppression apparatus is not greater than 0.05 m³.

The advantages of the aerosol fire suppression apparatus include: both the temperature of the wall and the temperature at the jet orifice are low, and the apparatus is compact and small, whose volume is not greater than 0.05 m³, and therefore is applicable to a variety of small spaces.

### BRIEF DESCRIPTION OF THE DRAWINGS

In order to make the above-mentioned advantages of the present invention be understood more clearly, the mini-type automatic aerosol fire suppression apparatus in the present invention will be further detailed with reference to the accompanying drawings.

FIG. 1 is a schematic structural diagram of an example of the mini-type automatic aerosol fire suppression apparatus in the present invention;

FIG. 2 is a schematic structural diagram of another example of the mini-type automatic aerosol fire suppression apparatus in the present invention.

In the figures: 1—top cap, 2—detection circuit board, 3—thermal insulating layer, 4—inner cylinder, 5—outer cylinder, 6—medical, 7—bottom cap, 8—sensing element, 9—screen, 10—cooling material, 11—igniter, 12—battery, 13—magnetic iron, 14—retaining ring, 15—asbestos board.

### DETAILED DESCRIPTION OF THE EMBODIMENTS

The present invention will be further detailed with reference to the drawings.

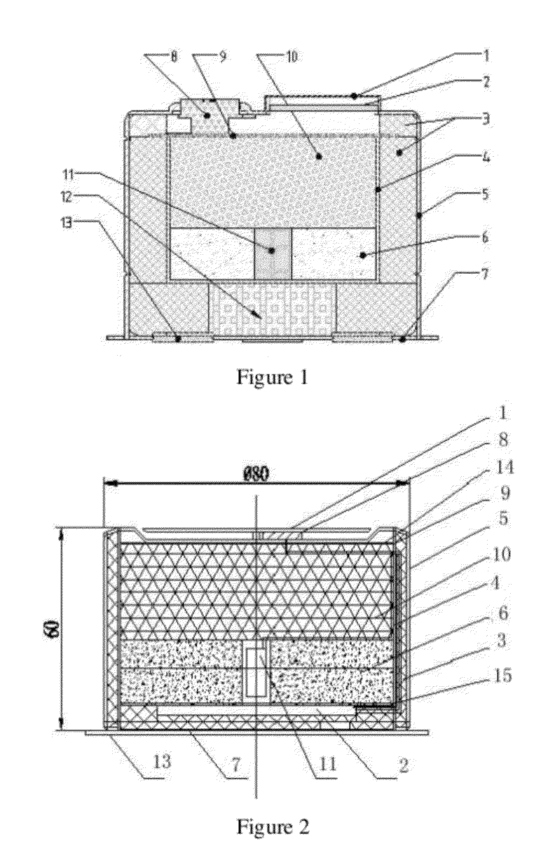

The mini-type automatic aerosol fire suppression apparatus shown in FIG. 1 employs an electric initiation approach and utilizes a battery for electric initiation. The apparatus comprises top cap 1, detection circuit board 2, thermal insulating layer 3, inner cylinder 4, outer cylinder 5, chemical agent 6, bottom cap 7, sensing element 8, screen 9, cooling layer 10, igniter 11, battery 12, and magnetic iron 13. Wherein the top cap 1 is installed on the top of the apparatus and the detection circuit board is arranged below the top cap. The top cap 1 makes the aerosol spurt out from the circumference of the top face of the apparatus.

The chemical agent 6 is installed in the inner cylinder 4 and the igniter 11 is installed at the center of the chemical agent 6. The igniter 11 can ignite the chemical 6 and thereby produce aerosol, such as a fire suppressant mainly made of strontium salt oxidizer.

In addition, the cooling layer 10 made of a cooling material is installed on top of the chemical agent 6 in the inner cylinder 4, the screen 9 covers the cooling layer 10, and a cooling material or cooling structure (e.g., a cellular ceramics structure) is arranged in the cooling layer. The aerosol generated in the above-described step passes through the cooling layer 10 and is cooled by the cooling layer 10, and then spurt out from the circumference of the top face of the apparatus, giving fire suppression effect.

In addition, a cylindrical outer cylinder 5 is arranged around the inner cylinder to provide protection. Moreover, a thermal insulating layer 3 is arranged between the inner cylinder 4 and the outer cylinder 5; the heat insulating material can be made of any appropriate material, such as aluminum silicate fiber to get the purpose of heat insulation.

In addition, a sensing element 8 (e.g., a temperature sensor) is installed on the top of the outer cylinder 8. In case of fire, the temperature sensor senses the fire and initiates the igniter 11 to ignite the chemical agent 6, which spurt aerosol to extinguish the fire quickly.

In addition, magnetic iron 13 and battery 12 are arranged at the bottom of the outer cylinder 5. The battery 12 supplies power to the igniter 11 and initiates the apparatus if desired. The apparatus is attached to the bottom cap 7 by means of the magnetic iron 13.

In addition, the detection circuit board 2 in the apparatus is designed to detect battery capacity at any time, so as to provide indication for battery replacement to avoid failure of initiation due to low battery.

Of course, the sensing element 8 in the apparatus can be of another type, such as temperature sensor, smoke detector, flame detector or gas detector; in addition, the temperature sensor can be a temperature sensing cable, thermal resistor, thermal switch, etc.

FIG. 2 is a schematic structural diagram of another example of the mini-type automatic aerosol fire suppression apparatus in the present invention. As shown in FIG. 2, the apparatus employs a non-electric initiation approach. The apparatus comprises top cap 1, sensing element 8, retaining ring 14, screen 9, outer cylinder 5, cooling layer 10, inner cylinder 4, chemical agent 6, thermal insulating layer 3, asbestos board 15, magnetic iron 13, bottom cap 17 and igniter 11, wherein the magnetic iron 13 is arranged below the apparatus and attached to the bottom cap.

In the apparatus, the aerosol fire suppressant in the chemical agent 6 is mainly made of potassium salt oxidizer, the thermal insulating layer 3 is made of asbestos material, and the cooling layer 10 is made of a chemical coolant (magnesium carbonate).

The non-electric initiation of the apparatus can be accomplished by connecting a heat-sensitive material, pyrophoric material or fire transfer material to the chemical agent. In addition, the heat-sensitive material, pyrophoric material or fire transfer material can be in any shape, such as linear shape, tabular shape, lumpy shape or powder. Furthermore, the mini-type automatic aerosol fire suppression apparatus can be installed by fixing with screws, attaching to the surface of an iron and steel structure by means of the magnetic iron 13 or bonding, but not limited to the fixing method in the example.

In case of fire, the sensing element 8 in the mini-type automatic aerosol fire suppression apparatus senses the fire and initiates the igniter 11 to ignite the medical in the chemical agent 6, so that aerosol spurts out to extinguish the fire quickly. Then the feedback element (buzzer) in the apparatus produces an alarm sound.

The advantages of the aerosol fire suppression apparatus include: both the temperature of the wall and the temperature at the jet orifice are low (the temperature at the jet orifice is lower than 150° C. and the temperature of the enclosure is lower than 100° C.). In addition, the apparatus is very delicate. Moreover, strontium salt oxidizer is used as the fire suppressant, so potential damage to the equipment from the products generated can be avoided when the aerosol burns.

Furthermore, since the volume of the entire apparatus is not greater than 0.05 m³, the apparatus is applicable to small spaces where power utilization, distribution and transformation is required, such as transformers, distribution cabinets, engine compartments and luggage compartments on vehicles, etc., and also applicable to locations where gasoline, diesel oil or aviation kerosene is used for propulsion, such as aircrafts, vehicles and ships, etc. In these circumstances, quick local fire suppression in a small scale may get twice the result with half the effort.

On the basis of the above instruction for the present invention, those skilled in the art can easily make modifications or variations of the examples without departing from the spirit of the present invention; however, all these modifications or variations shall be deemed as falling into the protected scope of the present invention. Those skilled in the art shall appreciate that the above description is only provided to elaborate and explain the object of the present invention, instead of constituting any confinement to the present invention. The protected scope of the present invention shall only be confined by the claims and their equivalence.

1. A mini-type automatic aerosol fire suppression apparatus, comprising top cap, thermal insulating layer, inner cylinder, outer cylinder, bottom cap, sensing element, screen and igniter, wherein a chemical agent and a cooling layer are installed in the inner cylinder, the thermal insulating layer is installed between the inner cylinder and the outer cylinder, and the sensing element is designed to sense fire.

2. The mini-type automatic aerosol fire suppression apparatus according to claim 1, characterized in that the initiation of the aerosol fire suppression apparatus is electric initiation, which is accomplished by means of the sensing element and a battery.

3. The mini-type automatic aerosol fire suppression apparatus according to claim 2, characterized in that the sensing element is a temperature sensor, smoke detector, flame detector or gas detector.

4. The mini-type automatic aerosol fire suppression apparatus according to claim 1, characterized in that the initiation of the aerosol fire suppression apparatus is non-electric initiation, which is accomplished by connecting a heat-sensitive material, pyrophoric material or fire transfer material to the chemical agent.

5. The mini-type automatic aerosol fire suppression apparatus according to claim 1, characterized in that the mini-type automatic aerosol fire suppression apparatus can be installed by fixing with screws, attaching to the surface of an iron and steel structure by means of the magnetic iron or bonding.

6. The mini-type automatic aerosol fire suppression apparatus according to claim 1, characterized in that it further comprises a detection circuit board, which is designed to detect battery capacity.

7. The mini-type automatic aerosol fire suppression apparatus according to claim 1, characterized in that a safety switch designed to prevent false initiation is arranged on the detection circuit board.

8. The mini-type automatic aerosol fire suppression apparatus according to claim 1, characterized in that it further comprises a feedback element designed to detect whether or not the apparatus spurts out the aerosol, and the feedback element is an indicator or buzzer.

9. The mini-type automatic aerosol fire suppression apparatus according to claim 1, characterized in that the thermal insulating layer is made of aluminum silicate fiber or asbestos material.

10. The mini-type automatic aerosol fire suppression apparatus according to claim 9, characterized in that the volume of the aerosol fire suppression apparatus is not greater than 0.05 m³.
